(19) United States
(12) Patent Application Publication
(10) Pub. No.: US 2025/0312873 A1
(43) Pub. Date: Oct. 9, 2025

(54) TIGHTENING CONTROL METHOD AND AUTOMATIC TIGHTENING DEVICE FOR AERO-ENGINE ROTOR BASED ON BOLT PRELOAD FEEDBACK

(71) Applicant: DALIAN UNIVERSITY OF TECHNOLOGY, Dalian (CN)

(72) Inventors: Qingchao SUN, Dalian (CN); Peng WANG, Dalian (CN); Xun WU, Dalian (CN); Jiahe ZHAO, Dalian (CN); Shugen LI, Dalian (CN); Xiaokai MU, Dalian (CN)

(21) Appl. No.: 19/240,962

(22) Filed: Jun. 17, 2025

Related U.S. Application Data
(63) Continuation of application No. PCT/CN2024/113835, filed on Aug. 22, 2024.

(51) Int. Cl. B23P 19/06

(52) U.S. Cl. CPC B23P 19/06

(57) ABSTRACT

The present invention belongs to the field of tightening control methods and automatic tightening technology, and discloses a tightening control method and automatic tightening device for an aero-engine rotor based on bolt preload feedback. The automatic tightening device is based on a main body structure and is provided with a rotary table structure, a spherical guide structure and a skid platform structure to achieve the degree of freedom of movement of the automatic tightening device for an aero-engine rotor within an inner cavity space of the rotor, enabling the tightening structure to be fed and withdrawn; in addition, a preload detection structure is provided, which relies on an ultrasonic preload measurement system to measure a real-time preload of a bolt during a tightening process and transmit the value of the preload to a tightening gun to achieve a tightening method for preload feedback control.

### TECHNICAL FIELD

The present invention belongs to the field of tightening control methods and automatic tightening technology, and relates to a tightening control method and automatic tightening device for an aero-engine rotor based on bolt preload feedback.

### BACKGROUND

The overall performance of an aero-engine is directly affected by the assembly quality of rotor connecting bolts. The internal structure of an aero-engine rotor is complex; the entrance is narrow and the entering depth is large; at the same time, the radial distance from bolts to the rotation center of the rotor is large, which brings great difficulties to the assembly. At present, during the assembly of engine rotors, manual mechanical tooling or devices with a relatively low degree of automation are mainly adopted to achieve bolt tightening; the assembly efficiency is low, the labor intensity of workers is high, the assembly quality is difficult to guarantee, and the assembly consistency is not ideal. At the same time, currently, the tightening of bolts is mostly carried out manually through a single torque method, with the aid of a torque wrench; the tightening efficiency is low, the tightening quality is difficult to guarantee, and the deviation of the preload of the tightened bolts can reach 25%-50%. Such problems restrict the improvement of rotor assembly quality to a certain extent, thereby affecting the performance of the aero-engine.

Zhao Bing et al. has disclosed a method for characterizing an actual preload of a bolt by the deformation of the bolt in a patent “an accurate control method for preload of aero-engine bolts”, in which a tensile force F is applied to a bolt with a tensile machine, an echo time T0 of the bolt before stretching and an echo time T1 of the bolt after stretching under the tensile force F are measured by an ultrasonic echo method, the tensile force is taken as a preload to establish a preload-acoustic time difference curve, thus to achieve the calibration of the preload of the bolt with a low error rate, and achieve the accurate control of the preload under different process parameters. However, the tightening method still adopts a manual form and does not achieve automatic tightening; moreover, an ultrasonic echo is only used for the calibration of the preload, and the closed-loop control of the preload is not achieved. Li Xiaoqiang et al. has disclosed an automatic tightening device for blind cavity nuts of an aero-engine compressor rotor in a patent “an automatic tightening device for blind cavity nuts of an aero-engine compressor rotor”, which realizes the automation of a tightening process and nut supply as well as the visualization of the tightening status, so as to improve the tightening efficiency and tightening accuracy. However, the controlled tightening process is still an open-loop process and will still generate a relatively large preload deviation.

In order to improve the assembly quality of engines, it is necessary to research a tightening control method and automatic assembly device for bolts. Aiming at the problem of preload deviation, the causes of the deviation in the existing tightening control methods are analyzed, and a tightening control method to reduce the preload deviation is proposed. Aiming at the problems of difficult tightening, low assembly efficiency and poor assembly quality of the complex structure of the rotor, the specific structure of the rotor is analyzed, and an automatic tightening device is designed to achieve efficient and high-quality tightening of bolts and improve the assembly performance.

### SUMMARY

The purpose of the present invention is to solve the problem of large dispersion of the tightening preload of the existing aero-engine rotor, and provide a feedback type tightening control method and automatic tightening device for an aero-engine rotor, wherein the tightening device can detect the preload thereof in real time, compare a current value with a given preload, control the speed of a motor, and thus to control the tightening of the motor. The present invention is capable of carrying out tightening work in the narrow space of an aero-engine. By using the feedback type tightening control method, the deviation of the preload is effectively reduced, and the consistency of tightening is ensured.

The technical solution of the present invention is as follows:

An automatic tightening device for an aero-engine rotor based on bolt preload feedback, comprising a main body structure 30, a rotary table structure 31, a spherical guide structure 32, a skid platform structure 33, a tightening structure 34, a connected piece structure 35 and an ultrasonic preload measurement system 36;

The main body structure 30 is mainly composed of supporting feet 2, a device substrate 3, supporting columns 4 and a platform plate 9, wherein four supporting feet 2 are fixed on the device substrate 3, the lower ends of the supporting columns 4 are fixed in the supporting feet 2, and the platform plate 9 is fixed on the upper ends of the supporting columns 4;

The connected piece structure 35 is mainly composed of a base bottom plate 5, bases 6 and a rotor 7, wherein four bases 6 are cylindrical, with the lower ends thereof fixed on the base bottom plate 5 and the upper ends thereof connected with the rotor 7; the connected piece structure 35 is fixed in the center of the device substrate 3 through the base bottom plate 5 and achieves a reverse torque of the automatic tightening device;

The rotary table structure 31 comprises a rotary table motor 10 and a rotary table 11, wherein the rotary table 11 is connected with the rotary table motor 10 to achieve rotation of the tightening device;

The spherical guide structure 32 is mainly composed of a ball screw 18, spherical guides 19 and a guide plate 20, wherein the platform plate 9 is connected below the rotary table 11, the guide plate 20 is connected above the rotary table 11, the guide plate 20 is provided with two spherical guides 19 and one ball screw 18, and the feeding and withdrawing actions of the tightening structure 34 can be achieved by turning a handle 28;

The skid platform structure 33 is mainly composed of a skid platform motor 12, a skid platform 13, a skid platform backplate 14 and a skid plate 15, wherein the spherical guides 19 and a slider of the ball screw 18 are connected with a skid platform bottom plate 16, the skid platform bottom plate 16 is connected with the skid platform 13 and the skid platform backplate 14, the top of the skid platform 13 is connected with the skid platform motor 12, and the skid platform 13 is also connected with the skid plate 15 to achieve the lifting and lowering movement of the tightening structure 34;

The tightening structure 34 is mainly composed of a tightening motor 21, a decelerator 22, a transverse gearbox 23 and a tightening sleeve 24, wherein one end of the transverse gearbox 23 is connected with the tightening sleeve 24, one end of the decelerator 22 is connected with the tightening motor 21, the other end of the decelerator 22 is connected with a mounting plate 17 and the transverse gearbox 23, and the mounting plate 17 passes through a through hole in the guide plate 20 and is connected with the skid plate 15;

The ultrasonic preload measurement system 36 is mainly composed of an ultrasonic probe 25, an oscillograph 26 and a PC module 27 which are connected in sequence, wherein a PLC controller communicates with the PC module 27 through a network cable in a ModbusTCP mode, the PC module 27 is connected with the oscillograph 26 through a network cable, the ultrasonic probe 25 is connected with the oscillograph 26, thus the mutual communication between the oscillograph 26 and the PC module 27, and between the PC module 27 and the PLC controller are achieved; in use, the ultrasonic probe 25 needs to be manually pressed against bolt heads of bolts to be tightened 8, and an actual value of a preload detected by the ultrasonic probe 25 can then be transmitted to the PLC controller.

The automatic tightening device also needs to be provided with an automatic control operating system, comprising an HMI touch screen, the PLC controller, servo motors, servo drivers, a 24V DC power supply, cables, etc.; the servo motors include: the rotary table motor 10, the skid platform motor 12 and the tightening motor 21; the HMI touch screen is connected with the PLC controller through a network cable to achieve human-machine interaction; the PLC controller is powered by the 24V DC power supply; the PLC controller is respectively connected with the servo drivers, the HMI touch screen and the ultrasonic preload measurement system 36; the servo drivers are powered by a 220V power supply to achieve the communication between the servo drivers and the PLC controller through a network cable; one end of a servo driver is connected with the PLC controller, and the other end is connected with a next servo driver to control multiple servo drivers by the PLC controller; at the same time, the servo drivers are connected with power lines of the servo motors and built-in encoder lines of the servo motors to control the servo motors.

A tightening control method for an aero-engine rotor based on bolt preload feedback, comprising the following steps:

Step 1: introducing a vector control of a preload loop;

The tightening motor 21 is a permanent magnet synchronous motor, a preload loop is introduced based on the three-closed-loop vector control of the permanent magnet synchronous motor, and the preload loop and a position loop are combined into a new preload loop to obtain a three-closed-loop vector control method for the new preload loop, a speed loop and a current loop; the bolts to be tightened 8 are installed on the rotor 7, an ultrasonic preload measurement method is used to detect the actual value of the preload of the bolts to be tightened 8 in the new preload loop in real time, the actual value of the preload is fed back to a Fuzzy PID controller, and a required rotational speed of the motor is calculated by the controller based on the difference between an expected value and the actual value and transmitted to the speed loop, thus to complete the control of a tightening process of the bolts to be tightened 8;

At the same time, the ultrasonic preload measurement system 36 will continue to collect the actual value of the preload of the bolts to be tightened 8;

Step 2: establishing a tightening angle-preload model based on a preload feedback method of the permanent magnet synchronous motor;

The tightening angle-preload model is used as a feedback link of a real-time preload, and the accuracy thereof has an important influence on the subsequent design of the Fuzzy PID controller and verification of modeling simulation;

In a torque-angle method, a connection stiffness is regarded as a constant, i.e., a tightening angle and a preload have a linear relationship. However, in an actual tightening process, due to the influence of factors such as a surface roughness at a connection point, as the tightening angle increases, the increase in the preload shows nonlinearity. The tightening angle-preload model is specifically expressed as:

$$θ = \frac{360 °}{P} {F}_{b} ( \frac{1}{{K}_{B}} + \frac{1}{{K}_{C}} + \frac{1}{{K}_{S}} + \frac{1}{{K}_{mth}} + \frac{1}{{K}_{m h d}} + \frac{1}{{K}_{m n u t}} ) \qquad ( 1 )$$

wherein θ is the tightening angle, P is a pitch, F_{b} is the preload of the bolts, K_{B} is a stiffness of the bolts, Kc is a stiffness of a connected piece, K_{S} is a stiffness of threads, Kₘₜₕ, K_{mhd} and Kₘₙᵤₜ are respectively a stiffness of threads, a stiffness of nuts and a stiffness of the bolt heads affected by the surface roughness; in formula (1), the nonlinearity of the connection stiffness caused by the surface roughness is taken into account, which can describe the relationship between a rotation angle and a preload more accurately during the tightening process, and provide a modeling basis for a tightening method for preload feedback control.

Step 3. designing the Fuzzy PID controller based on the preload feedback method;

The Fuzzy PID controller is designed based on the three-closed-loop vector control method and the established tightening angle-preload model, and the preload is accurately controlled by taking the actual value of the current preload as a feedback.

The actual value of the preload of the bolts to be tightened 8 is collected by the ultrasonic preload measurement system 36 and compared with a set final value of the preload, the obtained error e and an error change rate ec are used as input quantities and input into the Fuzzy PID controller, the error e and the error change rate ec are fuzzified by the Fuzzy PID controller, then a fuzzy control quantity is obtained through a fuzzy rule, an actual control quantity (i.e., a required speed value) is obtained after the fuzzy control quantity undergoes non-fuzzy processing, and the speed value is input into the speed loop, thus to control the tightening of the motor;

Step 4: building an experimental system;

The tightening motor 21, the skid platform 13, the rotary table motor 10 of the rotary table 11, and the skid platform motor 12 needs to be simultaneously controlled by the automatic tightening device which also communicates with the ultrasonic preload measurement system 36 to obtain the actual value of the preload of the bolts to be tightened 8;

The PLC controller is used as a control system which is divided into a hardware part and a software part, and an overall block diagram of the system is shown as follows. A control layer is composed of the tightening motor 21, the skid platform motor 12, the rotary table motor 10, and a movement control program written by a user; an electrical layer of the overall system is composed of the PLC controller, the ultrasonic preload measurement system 36, a switch used for increasing network cable interfaces, the servo motors, the servo drivers, the 220V power supply and the 24V DC power supply; an execution layer is composed of the tightening structure 34, the skid platform structure 33 and the rotary table structure 31; in the control layer, the program is written, the final value of the preload is set and a movement speed for the rotary table motor 10 and the skid platform motor 12 are set by the user, the real-time value of the current preload measured is transmitted to the PLC controller through the ultrasonic probe, and a Fuzzy PID control mode is adopted to specify the processing of the value of the preload and the rotational speed of the tightening motor 21 as well as the control of the tightening motor 21 by the PLC controller, i.e., the conversion between the control layer and the electrical layer is achieved by the PLC controller; similarly, the rotation, feeding and withdrawing actions of the tightening structure 34 are controlled through the rotation of the rotary table motor 10 and the skid platform motor 12, i.e., the conversion from the electrical layer to the execution layer is achieved by the servo motors and the servo drivers;

The PLC controller is powered by the 24V DC power supply. The PLC controller needs to be respectively connected with the servo drivers, the touch screen and the ultrasonic preload measurement system 36. The servo drivers used in an automatic control system are powered by the 220V power supply to achieve the communication between the servo drivers and the PLC controller through the network cable. One end of a servo driver is connected with the PLC controller, and the other end is connected with a next servo driver to control multiple servo drivers by the PLC controller. At the same time, the servo drivers need to be connected with the power lines and the built-in encoder lines of the servo motors to control the servo motors.

At the same time, for the motor of the electric skid platform, if a sudden power failure occurs and the motor is inoperative, it may cause a connected tightening part of the skid platform to fall vertically, posing a danger. Therefore, servo motors with a brake function need to be selected. Thus, for such servo motors, in addition to the conventional connection with the servo drivers, brake wires of the servo motors need to be connected with the 24V power supply. The PLC controller communicates with an ultrasonic measurement system through a network cable. At the same time, for the preload measurement of the ultrasonic preload measurement system 36, it is also required that the oscillograph is connected with the PC module 27 through a network cable. Therefore, a switch is used to increase network cable interfaces, so as to achieve the mutual communication between the oscillograph and the PC module 27, and between the PC module 27 and the PLC controller. The touch screen used for achieving human-machine interaction needs to be connected with the PLC controller through the network cable. Thus, an automatic tightening control system is preliminarily built.

Step 5: tightening preparation stage;

When the bolts to be tightened 8 of an aero-engine rotor are tightened, the rotor 7 is placed in a tightening position of the automatic tightening device and fixed; after the positioning of the automatic tightening device and the rotor 7 is completed, the tightening structure 34 is driven by the automatic tightening device to move and enter the rotor from an entrance of the rotor 7; then the tightening sleeve 24 is controlled by the movement control program to continue to move horizontally and rotate in space and achieve a capping action of the tightening sleeve 24; subsequently, the ultrasonic probe 25 of the ultrasonic preload measurement system 36 is pressed against the bolt heads of the bolts to be tightened 8 to ensure the real-time measurement of the preload;

Step 6: a tightening process according to preload feedback;

The tightening structure 34 is started to tighten the bolts to be tightened 8; a real-time preload is fed back by the ultrasonic preload measurement system 36 to the tightening motor 21, and when the bolts to be tightened 8 are tightened to the set final value of the preload, the tightening process of the bolts to be tightened 8 is ended; after the tightening of one bolt to be tightened 8 is completed, the tightening structure 34 is controlled by the movement control program to move upwards to ensure that the tightening sleeve 24 is separated from a nut, then the tightening sleeve 24 is moved to a next bolt to be tightened 8 through rotary movement, and the tightening action is repeated until all the bolts installed on the entire rotor 7 are tightened.

The present invention has the following beneficial effects: the present invention provides a feedback type tightening control method and automatic tightening device for an aero-engine rotor; aiming at the problem of the dispersion of the preload in the assembly of an aero-engine rotor, a preload feedback and control tightening method is proposed, which can effectively improve the control accuracy of the preload, reduce the dispersion of the preload, achieve the automation of tightening, and improve the efficiency.

One advantage of the present invention is that by providing the feedback type tightening control method and automatic tightening device for an aero-engine rotor, the present invention can perform a twisting operation on drum bolts of a rotor structure of a certain model of aero-engine in a set tightening sequence, thus to effectively improve the working efficiency and make the operation more convenient.

### DESCRIPTION OF DRAWINGS

FIG. 1 is a structural schematic diagram of an automatic tightening device for an aero-engine rotor of the present invention.

FIG. 2 is a three-dimensional diagram of a main body structure of an automatic tightening device for an aero-engine rotor of the present invention.

FIG. 3 is a three-dimensional diagram of a local structure of an automatic tightening device for an aero-engine rotor of the present invention.

FIG. 4 is a schematic diagram of a preload measurement system of an automatic tightening device for an aero-engine rotor of the present invention.

FIG. 5 is an assembly position diagram of an ultrasonic probe of a feedback type tightening control method for an aero-engine rotor of the present invention.

FIG. 6 is a flow chart of a feedback type tightening control program for an aero-engine rotor of the present invention.

FIG. 7 is an overall block diagram of a feedback type tightening control system for an aero-engine rotor of the present invention.

FIG. 8 is a schematic diagram of three-closed-loop vector control of a permanent magnet synchronous motor of the present invention.

In the figures: 1 fastening bolt; 2 supporting foot; 3 device substrate; 4 supporting column; 5 base bottom plate; 6 base; 7 rotor; 8 bolts to be tightened; 9 platform plate; 10 rotary table motor; 11 rotary table; 12 skid platform motor; 13 skid platform; 14 skid platform backplate; 15 skid plate; 16 skid platform bottom plate; 17 mounting plate; 18 ball screw; 19 spherical guide; 20 guide plate; 21 tightening motor; 22 decelerator; 23 transverse gearbox; 24 tightening sleeve; 25 ultrasonic probe; 26 oscillograph; 27 PC module; 28 handle; 30 main body structure; 31 rotary table structure; 32 spherical guide structure; 33 skid platform structure; 34 tightening structure; 35 connected piece structure; 36 ultrasonic preload measurement system.

### DETAILED DESCRIPTION

Specific embodiments of the present invention are further described below in combination with the drawings and the technical solution.

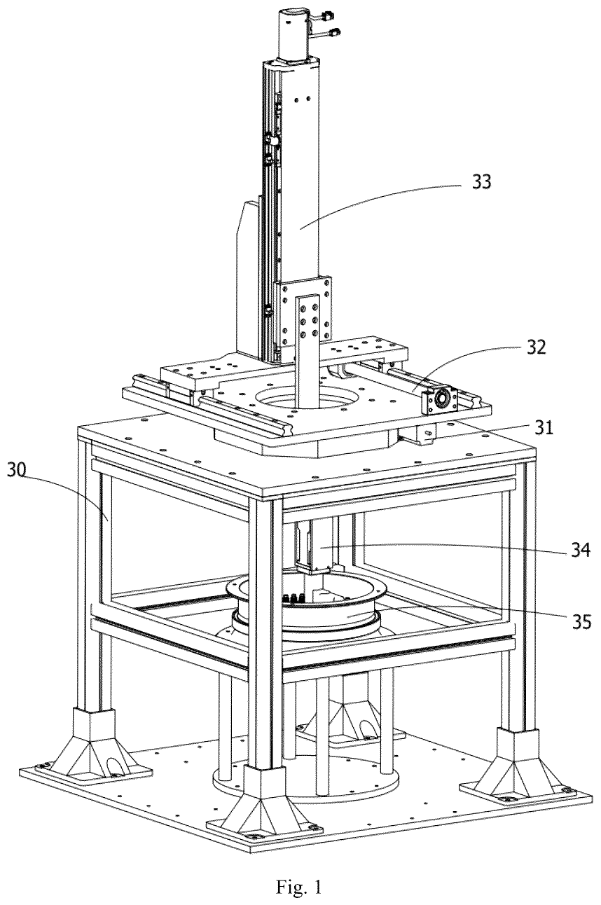

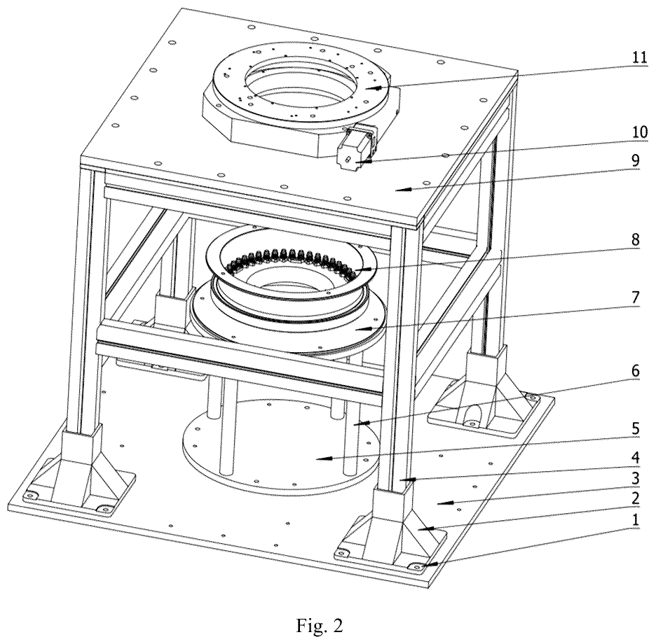

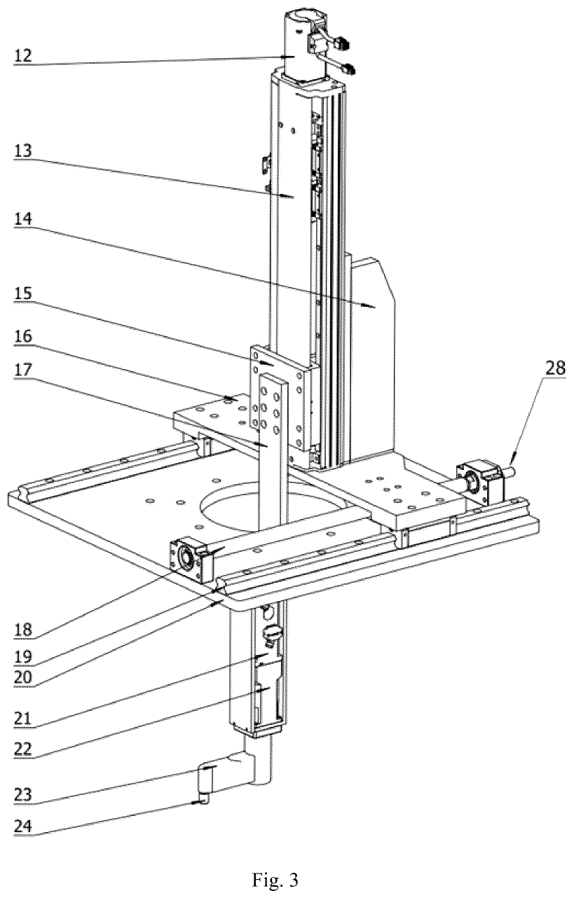

As shown in FIGS. 1-3, a feedback type tightening control method and automatic tightening device for an aero-engine rotor comprise a main body structure 30, a rotary table structure 31, a spherical guide structure 32, a skid platform structure 33, a tightening structure 34, a connected piece structure 35 and an ultrasonic preload measurement system 36.

A device substrate 3 is a square bottom plate, four supporting feet 2 are arranged on the device substrate 3 by fastening bolts 1, and four supporting columns 4 are inserted into the four supporting feet 2 and fixed by set screws. At the same time, eight bolt holes are formed in the center of the device substrate 3 and used for fixing bases 6 of a rotor 7, so as to achieve the fixation of the engine rotor connection parts, determine the positional relationship between the rotor and a tightening system, and achieve a reverse torque of an automatic tightening system. The rotor is provided with 48 bolts to be tightened 8.

A platform plate 9 is connected with the four supporting columns 4 by bolts to form a placement plane, a rotary table 11 is placed on the plane, bolt holes are formed in the platform plate 9 and the rotary table 11, the rotary table 11 is fixed on the platform plate 9 by bolt connection, and in addition, the rotary table 11 is connected with a motor 21 to drive the skid platform to rotate and achieve a rotation function of the device.

A guide plate 20 is connected with the upper surface of the rotary table 11 by bolts, and two spherical guides 19 and a ball screw 18 are arranged on the guide plate.

A skid platform bottom plate 16 is connected with the spherical guides 19 and the ball screw 18 by bolts. The skid platform bottom plate 16 is connected with a skid platform backplate 14, and a skid platform 13 is connected with the skid platform bottom plate 16 and skid platform backplate 14 respectively to be fixed. The top of the skid platform 13 is connected with a skid platform motor 12 to drive the skid platform. A skid plate 15 is connected with a mounting plate 17 with the tightening structure 34. Thus, the lifting, lowering, feeding and withdrawing functions of the tightening device are achieved.

The tightening structure 34 comprises a tightening motor 21, a decelerator 22, a transverse gearbox 23 and a tightening sleeve 24. One end of the decelerator 22 is connected with the tightening motor 21, the other end of the decelerator 22 is connected with the mounting plate 17 and the transverse gearbox, the motor and the decelerator are arranged in a space enclosed by the mounting plate 17, and one end of the transverse gearbox 23 is connected with the tightening sleeve 24. The transverse gearbox is used here for two considerations: first, due to the limitation of the internal dimensions and space of the rotor, the torque of a tightening gun cannot be directly output to a nut position of a tightening bolt, and therefore, a torque transmission mechanism is needed to perform radial torque transmission. Second, gear transmission has the advantages of relatively simple structure, stable torque transmission and simple torque transmission control mode.

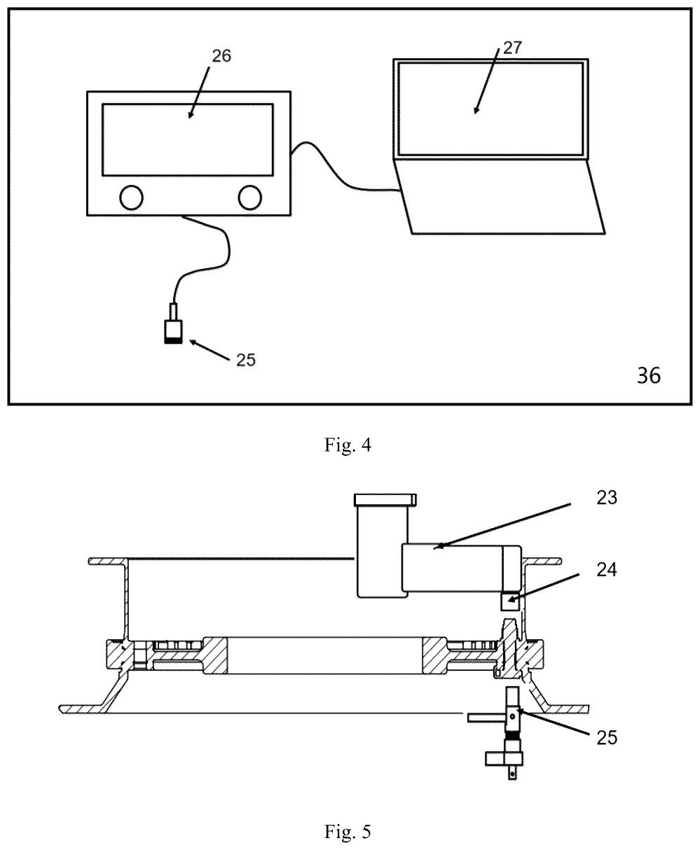

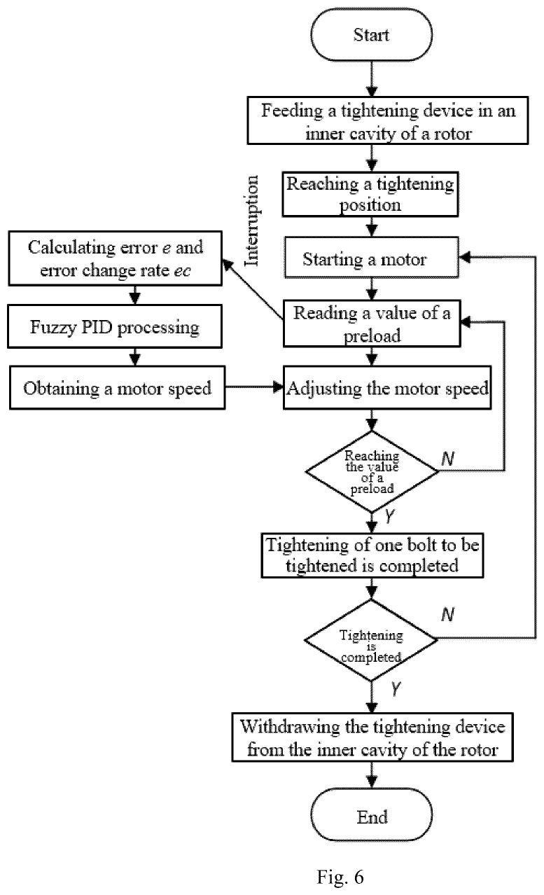

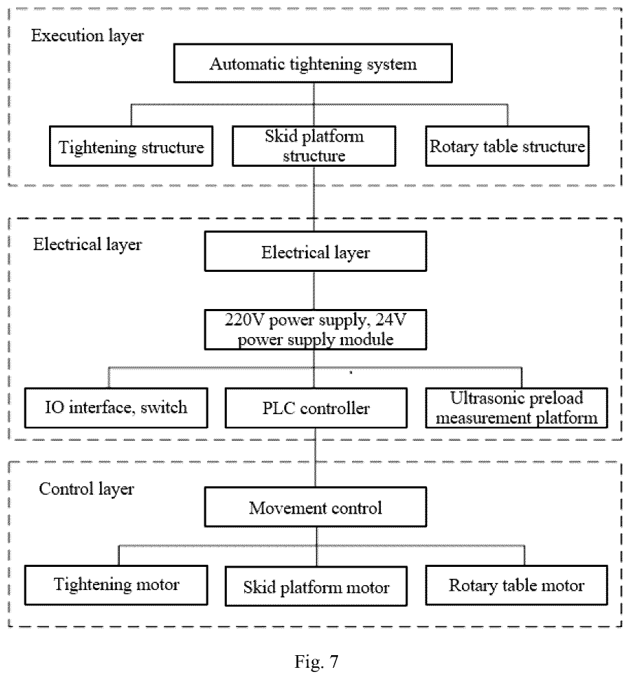

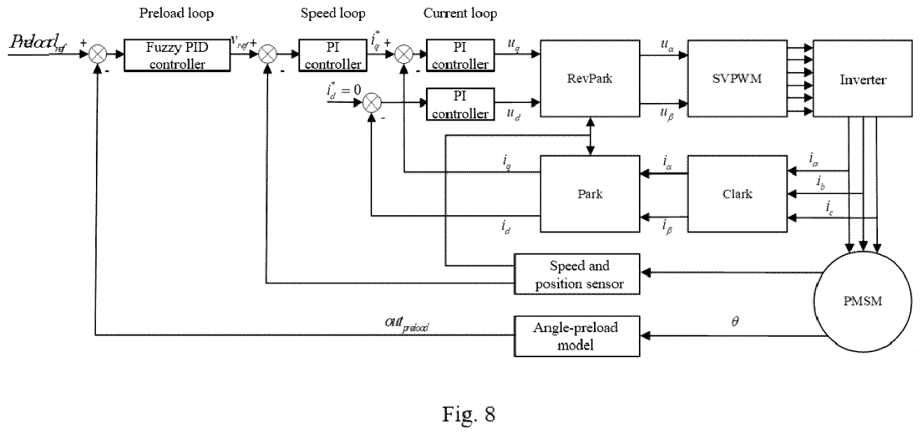

The ultrasonic preload measurement system 36 comprises an ultrasonic probe 25, an oscillograph 26 and a PC module 27, as shown in FIG. 4.

The automatic tightening device also needs to be provided with an automatic control operating system, comprising an HMI touch screen, a PLC controller, servo motors, servo drivers, a 24V DC power supply, cables, etc.

The present invention comprises the following implementation steps:

Step 1: introducing a vector control of a preload loop;

The tightening motor 21 is a permanent magnet synchronous motor, a preload loop is introduced based on the three-closed-loop vector control of the permanent magnet synchronous motor, and the preload loop and a position loop are combined into a new preload loop to obtain a three-closed-loop vector control method for the new preload loop, a speed loop and a current loop; the bolts to be tightened 8 are installed on the rotor 7, an ultrasonic preload measurement method is used to detect the actual value of the preload of the bolts to be tightened 8 in the new preload loop in real time, the actual value of the preload is fed back to a Fuzzy PID controller, and a required rotational speed of the motor is calculated by the controller based on the difference between an expected value and the actual value and transmitted to the speed loop, thus to complete the control of a tightening process of the bolts to be tightened 8;

The ultrasonic preload measurement system 36 will continue to collect the current preload of the bolts.

Step 2: establishing a tightening mathematical model based on a preload feedback method of the permanent magnet synchronous motor;

A tightening angle-preload model is used as a feedback link of a real-time preload, and the accuracy thereof has an important influence on the subsequent design of the Fuzzy PID controller and verification of modeling simulation;

In the tightening process of the bolts, the relationship between a rotation angle and a preload is shown in formula (2):

$$θ = \frac{360 °}{P} {F}_{b} ( \frac{1}{{K}_{B}} + \frac{1}{{K}_{C}} + \frac{1}{{K}_{S}} + \frac{1}{{K}_{mth}} + \frac{1}{{K}_{m h d}} + \frac{1}{{K}_{m n u t}} ) \qquad ( 2 )$$

wherein θ is a tightening angle, P is a pitch, F_{b} is the preload of the bolts, K_{B} is a stiffness of the bolts, K_{C} is a stiffness of a connected piece, K_{S} is a stiffness of threads, Kₘₜₕ, K_{mhd} and Kₘₙᵤₜ are respectively a stiffness of threads, a stiffness of nuts and a stiffness of bolt heads affected by a surface roughness; In formula (2), the nonlinearity of the connection stiffness caused by the surface roughness is taken into account, which can describe the relationship between a rotation angle and a preload more accurately during the tightening process, and provide a modeling basis for a tightening method for preload feedback control.

Step 3. designing the Fuzzy PID controller based on the preload feedback method;

The Fuzzy PID controller is designed based on a vector control theory of a three-phase permanent magnet synchronous motor and the established tightening angle-preload model, and the preload is accurately controlled by taking the actual value of the current preload as a feedback.

The preload of the bolts to be tightened 8 is collected by the ultrasonic preload measurement system 36 and compared with a final value of the preload set by a user, the obtained error e and an error change rate ec are used as input quantities and input into the Fuzzy PID controller, the error e and the error change rate ec are fuzzified by the Fuzzy PID controller, then a fuzzy control quantity is obtained through a fuzzy rule, an actual control quantity (i.e., a required rotational speed) is obtained after the fuzzy control quantity undergoes non-fuzzy processing, and the rotational speed is input into the speed loop, thus to control the tightening of the motor;

Step 4: building an experimental system;

The tightening motor 21, the skid platform 13, a rotary table motor 10 of the rotary table 11, and the skid platform motor 12 are simultaneously controlled by the automatic tightening device, and a control system needs to communicate with the ultrasonic preload measurement system 36, thus to input the collected actual value of the preload of the bolts to be tightened 8 into the control system;

The PLC controller is used as the control system which is divided into a hardware part and a software part, and an overall block diagram of the system is shown as follows. A control layer is composed of the tightening motor 21, the skid platform motor 12, the rotary table motor 10, and a movement control program written by a user; an electrical layer of the overall system is composed of the PLC controller, the ultrasonic preload measurement system 36, a switch used for increasing network cable interfaces, the servo motors, the servo drivers, a 220V power supply and the 24V DC power supply; an execution layer is composed of the tightening structure 34, the skid platform structure 33 and the rotary table structure 31. In the control layer, the program is written, the final value of the preload is set and a movement speed for the rotary table motor 10 and the skid platform motor 12 are set by the user, the real-time value of the current preload measured is transmitted to the PLC controller through the ultrasonic probe, and a Fuzzy PID control mode is adopted to specify the processing of the value of the preload and the rotational speed of the tightening motor 21 as well as the control of the tightening motor 21 by the PLC controller, i.e., the conversion between the control layer and the electrical layer is achieved by the PLC controller; similarly, the rotation, feeding and withdrawing actions of the tightening structure 34 are controlled through the rotation of the rotary table motor 10 and the skid platform motor 12, i.e., the conversion from the electrical layer to the execution layer is achieved by the servo motors and the servo drivers; the PLC controller is powered by the 24V DC power supply. The PLC controller needs to be respectively connected with the servo drivers, the touch screen and the ultrasonic preload measurement system 36. The servo drivers used in an automatic control system are powered by the 220V power supply to achieve the communication between the servo drivers and the PLC controller through the network cable. One end of a servo driver is connected with the PLC controller, and the other end is connected with a next servo driver to control multiple servo drivers by the PLC controller. At the same time, the servo drivers need to be connected with power lines of the servo motors and built-in encoder lines of the servo motors to control the servo motors.

At the same time, for the motor of the electric skid platform, if a sudden power failure occurs and the motor is inoperative, it may cause a connected tightening part of the skid platform to fall vertically, posing a danger. Therefore, servo motors with a brake function need to be selected. Thus, for such servo motors, in addition to the conventional connection with the servo drivers, brake wires of the servo motors need to be connected with the 24V power supply. The PLC controller communicates with an ultrasonic measurement system through a network cable. At the same time, for the preload measurement of the ultrasonic preload measurement system 36, it is also required that the oscillograph is connected with the PC module 27 through a network cable. Therefore, a switch is used to increase network cable interfaces, so as to achieve the mutual communication between the oscillograph and the PC module 27, and between the PC module 27 and the PLC controller. The touch screen used for achieving human-machine interaction needs to be connected with the PLC controller through the network cable. Thus, an automatic tightening control system is preliminarily built.

Step 5: tightening preparation stage;

The tightening system takes a preload of 45,000 N as a final value of a target preload. The rotor 7 is connected with the bases 6 to form the connected piece structure which is fixed in the center of the device substrate 3 by bolt connection. The rotary table motor 10 is started to rotate the rotary table and move the tightening structure to a position above the first bolt; a handle 28 is turned to make the tightening structure move radially to a position above a nut; the skid platform motor 12 is controlled to make a tightening head move downwards at a relatively high speed; when the tightening head reaches a position 2 centimeters above the tail of the bolt, the tightening head is switched to a low speed to make the tightening sleeve 24 slowly sheathed on the nut; the sleeve is rotated to cap the nut; at this point, the tightening system enters a tightening control program based on the preload feedback method and waits for tightening. The ultrasonic probe is pressed against the bolt heads of the bolts to be tightened 8 to detect the real-time preload during the tightening process.

Step 6: Tightening and obtaining the real-time preload;

The tightening motor 21 is started and the bolts begin to be tightened. One subprogram in the tightening control program is responsible for reading the real-time preload transmitted into the PLC controller from the ultrasonic preload measurement system 36 and storing the real-time preload in a corresponding variable. The error and the error change rate of the preload are calculated by another subprogram through a set preload and the real-time preload, thus to conduct fuzzy reasoning to obtain corresponding PID parameters and calculate a required speed at this moment. The rotational speed of the motor is adjusted by a main program in real time by interrupting the speed value calculated in the subprogram, and the bolts are finally tightened to the target preload to complete the tightening action.

The rotation of the tightening sleeve 24 is stopped, the skid platform 13 is controlled to move upwards, and the rotary table 11 is controlled to rotate to a next station until all the bolts are tightened.

Step 7: tightening end stage;

The skid platform 13 is controlled to move upwards, the rotor is withdrawn, the ball screw is turned to bring the tightening structure back to the center of the device, and the rotary table 11 is controlled to be straightened. The operating system is shut down, the power supply is turned off, and the rotor is removed from the tightening device.

1. A tightening control method for an aero-engine rotor based on bolt preload feedback, wherein an automatic tightening device used in the tightening control method for an aero-engine rotor comprises a main body structure (30), a rotary table structure (31), a spherical guide structure (32), a skid platform structure (33), a tightening structure (34), a connected piece structure (35) and an ultrasonic preload measurement system (36);
the main body structure (30) is mainly composed of supporting feet (2), a device substrate (3), supporting columns (4) and a platform plate (9), wherein four supporting feet (2) are fixed on the device substrate (3), the lower ends of the supporting columns (4) are fixed in the supporting feet (2), and the platform plate (9) is fixed on the upper ends of the supporting columns (4);
the connected piece structure (35) is mainly composed of a base bottom plate (5), bases (6) and a rotor (7), wherein four bases (6) are cylindrical, with the lower ends thereof fixed on the base bottom plate (5) and the upper ends thereof connected with the rotor (7); the connected piece structure (35) is fixed in the center of the device substrate (3) through the base bottom plate (5) and achieves a reverse torque of the automatic tightening device;
the rotary table structure (31) comprises a rotary table motor (10) and a rotary table (11), wherein the rotary table (11) is connected with the rotary table motor (10) to achieve rotation of the tightening device;
the spherical guide structure (32) is mainly composed of a ball screw (18), spherical guides (19) and a guide plate (20), wherein the platform plate (9) is connected below the rotary table (11), the guide plate (20) is connected above the rotary table (11), the guide plate (20) is provided with two spherical guides (19) and one ball screw (18), and the feeding and withdrawing actions of the tightening structure (34) can be achieved by turning a handle (28);
the skid platform structure (33) is mainly composed of a skid platform motor (12), a skid platform (13), a skid platform backplate (14) and a skid plate (15), wherein the spherical guides (19) and a slider of the ball screw (18) are connected with a skid platform bottom plate (16), the skid platform bottom plate (16) is connected with the skid platform (13) and the skid platform backplate (14), the top of the skid platform (13) is connected with the skid platform motor (12), and the skid platform (13) is also connected with the skid plate (15) to achieve the lifting and lowering movement of the tightening structure (34);
the tightening structure (34) is mainly composed of a tightening motor (21), a decelerator (22), a transverse gearbox (23) and a tightening sleeve (24), wherein one end of the transverse gearbox (23) is connected with the tightening sleeve (24), one end of the decelerator (22) is connected with the tightening motor (21), the other end of the decelerator (22) is connected with a mounting plate (17) and the transverse gearbox (23), and the mounting plate (17) passes through a through hole in the guide plate (20) and is connected with the skid plate (15);
the ultrasonic preload measurement system (36) is mainly composed of an ultrasonic probe (25), an oscillograph (26) and a PC module (27) which are connected in sequence, wherein a PLC controller communicates with the PC module (27) through a network cable in a ModbusTCP mode, the PC module (27) is connected with the oscillograph (26) through a network cable, the ultrasonic probe (25) is connected with the oscillograph (26), thus the mutual communication between the oscillograph (26) and the PC module (27), and between the PC module (27) and the PLC controller are achieved; in use, the ultrasonic probe (25) needs to be manually pressed against bolt heads of bolts to be tightened (8), and an actual value of a preload detected by the ultrasonic probe (25) can then be transmitted to the PLC controller;
the automatic tightening device is also equipped with an automatic control operating system, comprising an HMI touch screen, the PLC controller, servo motors, servo drivers, a 24V DC power supply and cables; the servo motors include: the rotary table motor (10), the skid platform motor (12) and the tightening motor (21); the HMI touch screen is connected with the PLC controller through a network cable to achieve human-machine interaction; the PLC controller is powered by a 24V DC power supply; the PLC controller is respectively connected with the servo drivers, the HMI touch screen and the ultrasonic preload measurement system (36); the servo drivers are powered by a 220V power supply to achieve the communication between the servo drivers and the PLC controller through a network cable; one end of a servo driver is connected with the PLC controller, and the other end is connected with a next servo driver to control multiple servo drivers by the PLC controller; at the same time, the servo drivers are connected with power lines of the servo motors and built-in encoder lines of the servo motors to control the servo motors; comprising the following steps:
step 1: introducing a vector control of a preload loop
the tightening motor (21) is a permanent magnet synchronous motor, a preload loop is introduced based on the three-closed-loop vector control of the permanent magnet synchronous motor, and the preload loop and a position loop are combined into a new preload loop to obtain a three-closed-loop vector control method for the new preload loop, a speed loop and a current loop; the bolts to be tightened (8) are installed on the rotor (7), an ultrasonic preload measurement method is used to detect the actual value of the preload of the bolts to be tightened (8) in the new preload loop in real time, the actual value of the preload is fed back to a Fuzzy PID controller, and a required rotational speed of the motor is calculated by the controller based on the difference between an expected value and the actual value and transmitted to the speed loop, thus to complete the control of a tightening process of the bolts to be tightened (8);
at the same time, the ultrasonic preload measurement system (36) will continue to collect the actual value of the preload of the bolts to be tightened (8);
step 2: establishing a tightening angle-preload model based on a preload feedback method of the permanent magnet synchronous motor
the tightening angle-preload model is specifically expressed as:
$$θ = \frac{360 °}{P} {F}_{b} ( \frac{1}{{K}_{B}} + \frac{1}{{K}_{C}} + \frac{1}{{K}_{S}} + \frac{1}{{K}_{mth}} + \frac{1}{{K}_{m h d}} + \frac{1}{{K}_{m n u t}} ) \qquad ( 1 )$$
wherein θ is a tightening angle, P is a pitch, F_{b} is the preload of the bolts, K_{B} is a stiffness of the bolts, K_{C} is a stiffness of a connected piece, K_{S} is a stiffness of threads, Kₘₜₕ, K_{mhd} and Kₘₙᵤₜ are respectively a stiffness of threads, a stiffness of nuts and a stiffness of bolt heads affected by a surface roughness;
step 3: designing the Fuzzy PID controller based on the preload feedback method
the Fuzzy PID controller is designed based on the three-closed-loop vector control method and the established tightening angle-preload model, and the preload of the bolts to be tightened (8) is controlled by taking the actual value of the current preload as a feedback;
the actual value of the preload of the bolts to be tightened (8) is collected by the ultrasonic preload measurement system (36), the actual value of the preload is compared with a set final value of the preload, the obtained error e and an error change rate ec are used as input quantities and input into the Fuzzy PID controller, the error e and the error change rate ec are fuzzified by the Fuzzy PID controller, then a fuzzy control quantity is obtained through a fuzzy rule, an actual control quantity (i.e., a required speed value) is obtained after the fuzzy control quantity undergoes non-fuzzy processing, and the speed value is input into the speed loop, thus to control the tightening of the tightening motor;
step 4: building an experimental system;
the tightening motor (21), the rotary table motor (10) of the rotary table (11), and the skid platform motor (12) are simultaneously controlled by the automatic tightening device, and a control system needs to communicate with the ultrasonic preload measurement system (36), thus to input the collected actual value of the preload of the bolts to be tightened (8) into the control system;
the PLC controller is used as the control system which is divided into a control layer, an electrical layer and an execution layer; the control layer is composed of the tightening motor (21), the skid platform motor (12), the rotary table motor (10), and a movement control program written by a user; the electrical layer is composed of the PLC controller, the ultrasonic preload measurement system (36), a switch used for increasing network cable interfaces, the servo motors, the servo drivers, the 220V power supply and the 24V DC power supply; the execution layer is composed of the tightening structure (34), the skid platform structure (33) and the rotary table structure (31); in the control layer, the movement control program is written, the final value of the preload is set and a movement speed for the rotary table motor (10) and the skid platform motor (12) are set by the user, the actual value of the current preload measured is transmitted to the PLC controller through the ultrasonic probe (25), and a Fuzzy PID control mode is adopted to specify the processing of the actual value of the preload and the rotational speed of the tightening motor (21) as well as the control of the tightening motor (21) by the PLC controller, i.e., the conversion between the control layer and the electrical layer is achieved by the PLC controller; similarly, the rotation, feeding and withdrawing actions of the tightening structure (34) are controlled through the rotation of the rotary table motor (10) and the skid platform motor (12), i.e., the conversion from the electrical layer to the execution layer is achieved by the servo motors and the servo drivers; the PLC controller is powered by the 24V DC power supply; the PLC controller is respectively connected with the servo drivers, the HMI touch screen and the ultrasonic preload measurement system (36); the servo drivers used in the electrical layer are powered by the 220V power supply to achieve the communication between the servo drivers and the PLC controller through the network cable; one end of a servo driver is connected with the PLC controller, and the other end is connected with a next servo driver to control multiple servo drivers by the PLC controller; at the same time, the servo drivers are connected with the power lines of the servo motors and the built-in encoder lines of the servo motors to control the servo motors;
step 5: tightening preparation stage
when the bolts to be tightened (8) of an aero-engine rotor are tightened, the rotor (7) is placed in a tightening position of the automatic tightening device and fixed;
after the positioning of the automatic tightening device and the rotor (7) is completed, the tightening structure (34) is driven by the automatic tightening device to move and enter the rotor from an entrance of the rotor (7); then the tightening sleeve (24) is controlled by the movement control program to continue to move horizontally and rotate in space and achieve a capping action of the tightening sleeve (24); subsequently, the ultrasonic probe (25) of the ultrasonic preload measurement system (36) is pressed against the bolt heads of the bolts to be tightened (8) to ensure the real-time measurement of the preload;
step 6: a tightening process according to preload feedback
the tightening structure (34) is started to tighten the bolts to be tightened (8); a real-time preload is fed back by the ultrasonic preload measurement system (36) to the tightening motor (21), and when the bolts to be tightened (8) are tightened to the set final value of the preload, the tightening process of the bolts to be tightened (8) is ended; after the tightening of one bolt to be tightened (8) is completed, the tightening structure (34) is controlled by the movement control program to move upwards to ensure that the tightening sleeve (24) is separated from a nut, then the tightening sleeve (24) is moved to a next bolt to be tightened (8) through rotary movement, and the tightening action is repeated until all the bolts installed on the entire rotor (7) are tightened.
